(19) United States
(12) Patent Application Publication
(10) Pub. No.: US 2017/0285739 A1
(43) Pub. Date: Oct. 5, 2017

(54) Methods and Apparatus for Repositioning a Computer Display Based on Eye Position

(71) Applicant: International Business Machines Corporation, Armonk, NY (US)

(72) Inventors: Andrew S. Aaron, Ardsley, NY (US); Mishal Dholakia, Danbury, CT (US); Shang Q. Guo, Cortland Manor, NY (US); Jonathan Lenchner, North Salem, NY (US); Daniel A. Mazzella, Henderson, NV (US)

(21) Appl. No.: 15/089,975

(22) Filed: Apr. 4, 2016

(51) Int. Cl. G06F 3/01; G09G 3/20; G06F 3/0488

(52) U.S. Cl. CPC G06F 3/013; G06F 3/012; G06F 3/04886; G09G 3/20

(57) ABSTRACT

Methods, systems, and computer program products are provided that facilitate a user operating a computing device in an atypical body position, such as using a computing device while lying in a horizontal position. An exemplary computer-implemented method can include providing an adjustable display for a computing system of a user; obtaining one or more images of the user from a vicinity of the adjustable display; evaluating a relative position of one or more of eyes and ears of the user and the adjustable display using the one or more images to determine whether the user is facing the adjustable display; and readjusting one or more of a position and an orientation of the adjustable display based on the relative position.

### FIELD

The present application generally relates to computer presentation techniques, and, more particularly, to methods and apparatus for allowing a user to operate a computing device in an atypical body position.

### BACKGROUND

Computing devices, such as laptop computers and other electronic media devices, are increasingly affordable, powerful and portable. In addition, users increasingly rely on devices for many purposes including work and entertainment, in a variety of locations. For example, many users surf the Internet, watch movies, and/or compose documents from a comfortable position in bed or in outdoor locations.

Existing computer stands for laptops and other computing devices are typically designed for use in an upright, seated position, that doesn't easily accommodate atypical body positions, such as a user lying down in a horizontal position while using the computing device. Some users employ computing devices from atypical body positions since they find sitting or lying in bed is more comfortable than using a traditional chair or standing position. Other users must spend much of their time in bed for medical reasons, such as users having back problems or users who are confined to a bed. In both cases, appropriate hardware and software may be necessary to permit effective use of either a laptop or desktop computer.

A need therefore exists for improved techniques that facilitate a user operating a computing device in an atypical body position, such as using a computing device while lying in a horizontal position.

### SUMMARY

In one embodiment of the present invention, techniques are provided that facilitate a user operating a computing device in an atypical body position, such as using a computing device while lying in a horizontal position. An exemplary computer-implemented method can include providing an adjustable display for a computing system of a user; obtaining one or more images of the user from a vicinity of the adjustable display; evaluating a relative position of one or more of the eyes and ears of the user and the adjustable display using the one or more images to determine whether the user is facing the adjustable display; and readjusting one or more of a position and an orientation of the adjustable display based on the relative position.

Another embodiment of the invention or elements thereof can be implemented in the form of an article of manufacture tangibly embodying computer readable instructions which, when implemented, cause a computer to carry out a plurality of method steps, as described herein. Furthermore, another embodiment of the invention or elements thereof can be implemented in the form of an apparatus including a memory and at least one processor that is coupled to the memory and configured to perform the noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates an exemplary computing device, according to one embodiment of the invention;

FIG. 2 illustrates an exemplary user in a horizontal position viewing the adjustable display of FIG. 1;

FIGS. 3A and 3B illustrate the positioning of the adjustable display of FIG. 1 from various positions near a bed;

FIGS. 4A through 4C illustrate readjusting the adjustable display positioned above a user while lying on a bed, based on the movements of the user;

FIG. 5 is a flow chart illustrating an exemplary implementation of an automatic orientation process, according to one embodiment of the invention; and

FIG. 6 is a system diagram of an exemplary computer system on which at least one embodiment of the invention can be implemented.

### DETAILED DESCRIPTION

Illustrative embodiments of the present invention will be described herein with reference to exemplary communication, storage, and processing devices. It is to be appreciated, however, that the invention is not restricted to use with the particular illustrative configurations shown. One or more embodiments of the present invention provide methods and apparatus for repositioning a computer display based on a user's eye position. In one or more embodiments, the disclosed system repositions an adjustable display based on one or more of a learned comfort profile of the user and a current position and orientation of the user's visual focus (e.g., based on where the user is currently looking).

Another aspect of the invention includes one or more wireless mouse-keyboards that can be positioned by the user, such as at the user's sides when lying down. In one or more embodiments, wireless mouse-keyboards are implemented virtually using pressure-sensitive and/or infrared sensing touch surfaces. The wireless mouse-keyboards optionally measure key touches and determine which key is touched by which finger of the user. In addition, a virtual keyboard can optionally be projected or displayed on a display and optionally includes a transparent hand model rendering to help the user with keyboard input without requiring that the user see the real keyboard.

A further aspect of the invention employs one or more helper layers incorporated into the visual output. The helper layers optionally present one or more of the virtual keyboard and virtual hand position renderings, integrated with the traditional output of the computing device.

In one or more embodiments, methods and systems are provided to automatically adjust a display to a predefined comfortable position (e.g., in a user profile; or a default position if a comfortable position has not yet been defined) of a user via motors for the user. Existing head pose estimation techniques are applied to determine where the user is looking by calculating relative angles to the camera via images from the camera. Thereafter, the additional delta angles are calculated for adjusting the display to the predefined comfortable position.

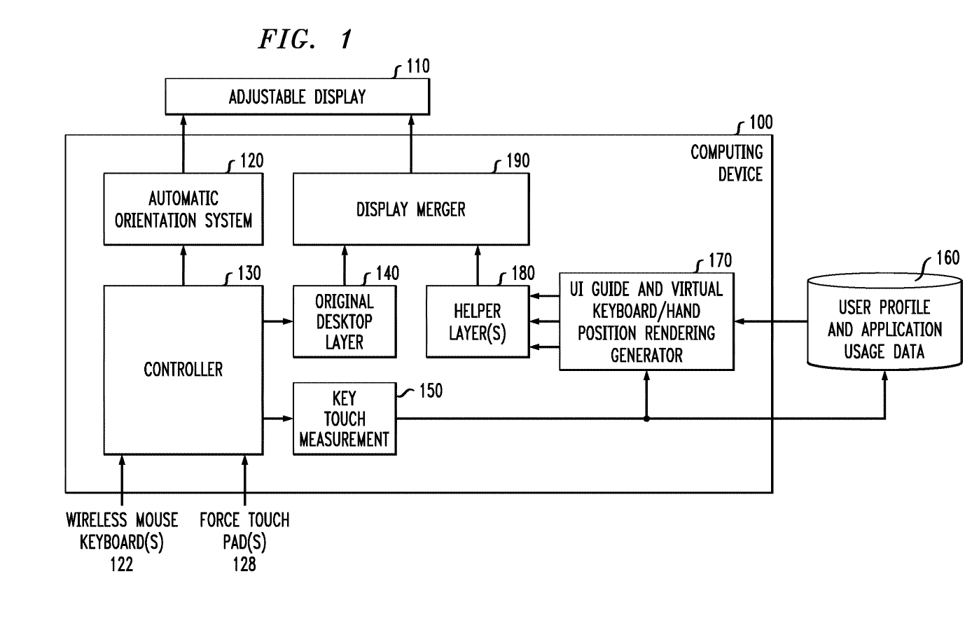

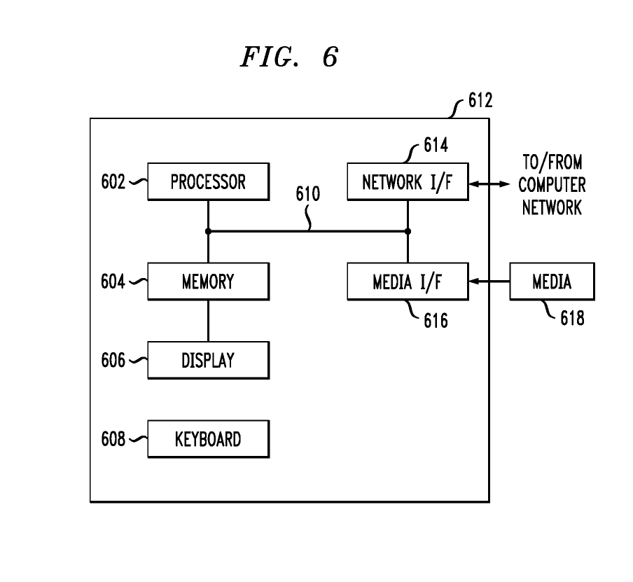

FIG. 1 illustrates an exemplary computing device 100, according to one embodiment of the invention. Additional details of the exemplary computing device 100 are discussed further below in conjunction with FIG. 6. As shown in FIG. 1, the exemplary computing device 100 interacts with an adjustable display 110 that provides a visual output to a user (not shown).

In addition, a user may interact with a graphical user interface provided by a controller 130 of the exemplary computing device 100 using one or more wireless mouse-keyboards 122 and/or one or more force-enabled touch pads 128. For example, one wireless mouse-keyboard 122 can be provided for each hand of a user. The wireless mouse-keyboards 122 are optionally implemented virtually using the force-enabled touch pads 128 that comprise pressure-sensitive and/or infrared sensing touch surfaces. A key touch measurement module 150 optionally measure key touches on the wireless mouse-keyboards 122 and determines which key is touched by which finger of the user.

In addition, a user interface (UI) guide and virtual keyboard/hand position rendering generator 170 processes the key touch measurements from the key touch measurement module 150 and user profile information from a user profile and application usage database 160 to generate a virtual keyboard and an optional transparent hand model rendering to help the user with keyboard input without requiring that the user see a real keyboard. The rendering generator 170 can render a hand outline for each of the two hand positions on a presented virtual keyboard and can also indicate which keys are being touched by which fingers, for example, with a highlighting technique, such as placing green circles around active fingers.

The generated virtual keyboard can optionally be projected, for example, on the ceiling or another surface, or displayed on adjustable display 110. In this manner, the infrared-based measurements or pressure-sensitive touch screen techniques can be used to infer the user's finger positions, and then render the user's hands and key touches on the adjustable display 110 or projected virtual keyboard. With this visual keyboard display, the user can view his finger positions without seeing the real keyboard.

In one or more embodiments, the user interface (UI) guide and virtual keyboard/hand position rendering generator 170 generates the rendering on one or more helper layer(s) 180 integrated with the original desktop layer 140 of the computing device 100. The helper layer 180 can be selectively enabled by the user in the visual output. An optional UI guide can be presented on a helper layer 180 to assist users comprising, for example, auto-completion options and helpful tips. In one embodiment, the virtual keyboard display and UI guide are presented on separate helper layer(s) 180 having a transparent background. A display merger module 190 in the exemplary computing device 100 merges the help layers 180 with the original desktop layer 140 generated by the controller 130 to form the final desktop for the operating system to present on the adjustable display 110.

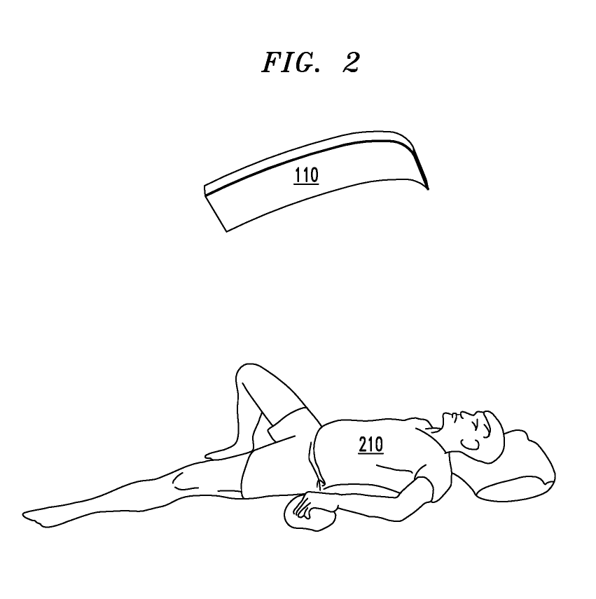

As discussed further below in conjunction with FIGS. 2-4, the visual output of the exemplary computing device 100 can be (i) projected on a surface the user can see while laying down, for example, the ceiling, and/or (ii) displayed on a computer screen moved into view using manual force and/or using a motor assembly from the side or back, and then adjusted to a comfortable position (either manually or automatically).

In the exemplary embodiment of FIG. 1, the exemplary computing device 100 comprises an automatic orientation system 120 that automatically controls the orientation of the adjustable display 110. The exemplary automatic orientation system 120 evaluates the relative position of the adjustable display 110 and the current orientation of the user's visual focus and repositions the adjustable display 110 based on a learned comfort profile of the user and the current orientation of the user's visual focus (e.g., based on where the user is currently looking).

The adjustable display 110 is optionally reset back to its home position after the exemplary computing device 100 is left idle or does not have the user's attention for a configurable and/or predefined period of time.

The exemplary computing device 100 optionally records user interactions and builds up a user's profile in the user profile and application usage database 160. In this manner, the exemplary computing device 100 can learn user's typing behavior and infer the user's intent based on historical data in the user profile and application usage database 160.

FIG. 2 illustrates an exemplary user 210 in a horizontal position viewing the adjustable display 110 of FIG. 1. According to one or more embodiments of the invention, the automatic orientation system 120 of FIG. 1 automatically controls the orientation of the adjustable display 110 based on an evaluation of the relative position of the adjustable display 110 and the current orientation of the visual focus of the user 210. In this manner, the orientation of the adjustable display 110 can be repositioned based on the learned comfort profile of the user and/or the current orientation of the visual focus of the user 210 (e.g., based on where the user 210 is currently looking).

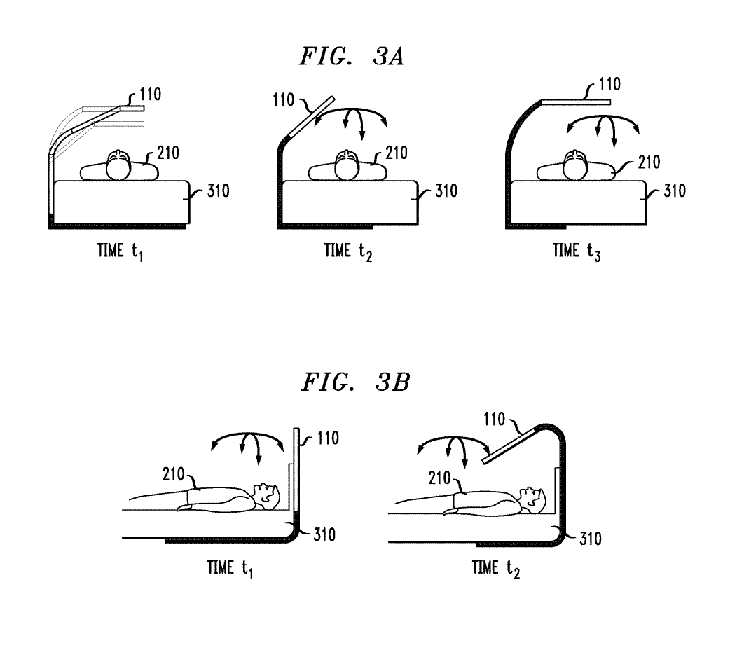

FIG. 3A illustrates the positioning of the adjustable display 110 from a position near the side of a bed 310. As shown in FIG. 3A, at a time t₁, the adjustable display 110 is positioned at a disengaged position near the side of a bed 310. At a time t₂, the user 210 initiates a movement of the adjustable display 110 from the disengaged position to a position over the user 210 on the bed 310 (either manually or automatically). Finally, at a time t₃, the adjustable display 110 has been repositioned in an engaged position above the user 210 and the bed 310. In one or more embodiments, both the height and orientation of the adjustable display 110 can be adjusted.

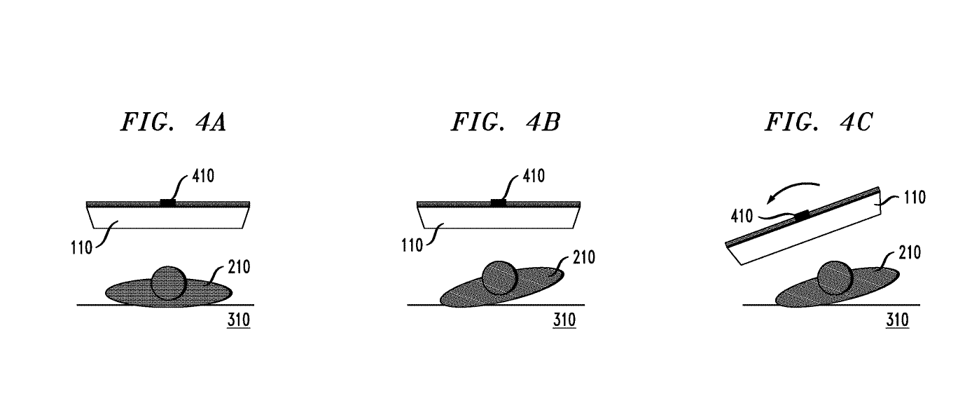

As discussed further below in conjunction with FIG. 4, the exemplary computing device 100 uses a camera installed at the top of the adjustable display 110 to capture the eye position of the user and then adjusts the position and orientation of the adjustable display 110 based on the relative position of the eyes of the user 210 and the adjustable display 110.

FIG. 3B illustrates the positioning of the adjustable display 110 from a position near the head (e.g., head board) of a bed 310. As shown in FIG. 3B, at a time t₁, the adjustable display 110 is positioned at a disengaged position near the head of bed 310. At a time t₂, the user 210 initiates a movement of the adjustable display 110 from the disengaged position to an engaged position over the user 210 on the bed 310 (either manually or automatically).

FIGS. 4A through 4C illustrate the adjustable display 110 positioned above the user 210 while the user 210 is lying on a bed 310, based on the movements of the user. The adjustable display 110 has a camera 410 to capture the eye position of the user. The camera 410 can be implemented, for example, as a forward-pointing camera that faces the normal position of the user 210 on the bed 310. The camera 410 can be mounted on the adjustable display 110 or embedded in the adjustable display 110 to capture the eye positions of each user.

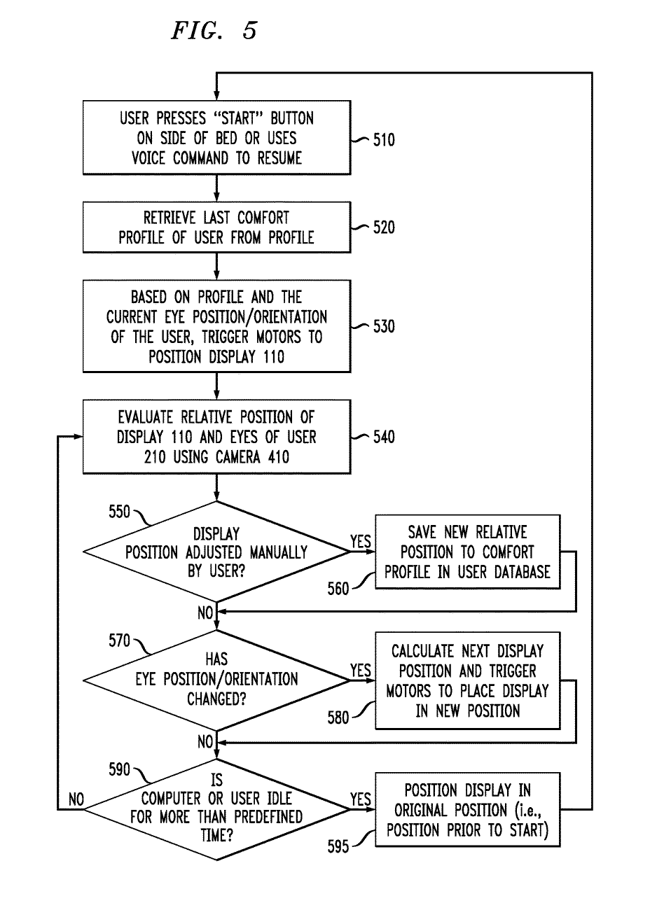

The images from camera 410 are processed by the automatic orientation system 120 to evaluate the relative position of the eyes of the user 210 and the adjustable display 110 and generate a corresponding adjustment to the position and/or orientation of the adjustable display 110, as discussed further below in conjunction with FIG. 5.

As shown in FIG. 4A, the user 210 is lying flat on the bed 310 in a neutral or comfortable position and the adjustable display 110 has an orientation that is square with the orientation of the user 210, referred to as the neutral or comfortable monitor position. The neutral or comfortable monitor position can be different from person to person and stored in the user profile and application usage data 160. In this manner, the system stores the relative position of the adjustable display 110 with respect to the eye position of the user 210 from session to session. As the automatic orientation system 120, discussed further below in conjunction with FIG. 5, learns what the user finds comfortable, the automatic orientation system 120 begins to automatically adjust the adjustable display 110 based on the eye position of the user 210 as detected by the camera 410.

In FIG. 4B, the user 210 has shifted his or her position such that the right shoulder is lifted from the bed 310 and the user is looking in an upward left direction. The change in relative position of the eyes of the user 210 and the adjustable display 110 is captured by camera 410 and detected by the automatic orientation system 120. When the automatic orientation system 120 detects that the relative position of the eyes of the user 210 and the adjustable display 110 have been changed, the automatic orientation system 120 automatically adjusts the position and/or orientation of the adjustable display 110.

As shown in FIG. 4C, the automatic orientation system 120 has generated a corresponding adjustment to the position and/or orientation of the adjustable display 110 to maintain the square orientation between the adjustable display 110 and the orientation of the user 210.

FIG. 5 is a flow chart illustrating an exemplary implementation of an automatic orientation process 500, according to one embodiment of the invention. As shown in FIG. 5, the exemplary automatic orientation process 500 is initiated during step 510, for example, when a user 210 presses a “start” button on the side of the bed 310 or uses an alphanumeric or voice command to resume. It is noted that the adjustable display 110 can optionally be set to a pre-set position the first time a given adjustable display 110 is used for a given user 210.

The last comfort profile of the user 210 is retrieved from the profile 160 during step 520. Thereafter, based on the user profile and the current eye position/orientation of the user, the motors of the adjustable display 110 are triggered during step 530 to position the adjustable display 110.

The relative position of the adjustable display 110 and the eyes of the user 210 are evaluated during step 540 using the camera 410 and the automatic orientation system 120 (e.g., using image processing of the facial pose).

In an embodiment where the determination of whether the user is facing the display is based on image processing to determine a facial pose of the user 210, predefined criteria can be established to define when a user 210 is “facing” the display. For example, the predefined criteria can require that a certain percentage of the nose of the user 210 is visible in the generated images and/or that a certain percentage of one or both eyes of the user 210 are visible in the generated images. In another variation, the predefined criteria can be based on a measured orientation of the facial pose of the user 210. For example, a score can be assigned to the facial pose of the user 210 indicating a degree to which the user is facing the adjustable display 110. The facial pose score can be compared to a corresponding threshold to determine if the user 210 is facing the adjustable display 110.

Generally, if the user 210 is directly facing the adjustable display 110, the nose of the user 210 and/or both eyes of the user 210 will be visible in the images generated by the camera 410. Likewise, if the user 210 is not facing the adjustable display 110, the full nose of the user 210 and/or both eyes of the user 210 will not be visible in the images generated by the camera 410.

In the context of computer vision, head pose estimation is commonly interpreted as an ability to infer the orientation of a person's head relative to the view of a camera 410. Head pose estimation requires a series of processing steps to transform a pixel-based representation of a head into a high-level concept of direction. For example, the facial pose of the user 210 can optionally be processed to determine whether a nose and/or both eyes of the user 210 are substantially visible as a front-facing view in images generated by a camera 410 associated with the adjustable display 110. A score can optionally be assigned to the facial pose of the user 210 indicating a degree to which the user is facing the adjustable display 110.

For a more detailed discussion of suitable techniques for determining the facial pose of the user 210, see, for example, W. Zhao et al., “Face recognition: A ,” ACM Computing Surveys, pp. 399-458 (2003); A. Nikolaidis and I. Pitas, “Facial Feature Extraction and Determination of Pose,” Pattern Recognition, 33: 1783-1791 (2000); and/or U.S. Pat. No. 6,937,745, entitled “Machine Vision System and Method for Estimating and Tracking Facial Pose,” each incorporated by reference herein.

A test is performed during step 550 to determine if the position of the adjustable display 110 is manually adjusted by the user 210. If it is determined during step 550 that the position of the adjustable display 110 has been manually adjusted by the user 210, then the new relative position is saved during step 560 to the comfort profile of the user 210 in the user database 160, before proceeding to step 570.

If, however, it is determined during step 550 that the position of the adjustable display 110 has not been manually adjusted by the user 210, then a test is performed during step 570 to determine if the eye position/orientation of the user 210 has changed. If it is determined during step 570 that the eye position/orientation of the user 210 has changed, then the next display position is calculated during step 580 and the motors of the adjustable display 110 are triggered to place the adjustable display 110 in the new position, before proceeding to step 590.

If, however, it is determined during step 570 that the eye position/orientation of the user 210 has not changed, then a test is performed during step 590 to determine if the exemplary computing device 100 or the user 210 has been idle for more than a predefined time (e.g., no user interactions or the eyes of the user 210 are closed). The predefined time is optionally configurable by the user 210. If it is determined during step 590 that the computing device 100 and/or the user 210 have been idle for more than the predefined time, then the adjustable display 110 is repositioned during step 595 into its original position (e.g., a position prior to starting in step 510), before proceeding to step 510.

If, however, it is determined during step 590 that the computing device 100 and/or the user 210 have not been idle for more than the predefined time, then program control returns to step 540 and continues in the manner described above.

Among other benefits, the disclosed techniques for facilitating a user 210 to operate a computing device 100 in an atypical body position, such as the user 210 lying in a horizontal position on a bed 310 while using the computing device 100, provide more flexibility in the viewing options available to computer users. An exemplary computing device 100 comprises a display component 110, such as a projector or an adjustable display, that can be automatically repositioned, for example, with the aid of a motor assembly, to accommodate a learned comfort profile and/or current position of the user. In addition, in one or more embodiments, the disclosed computing device 100 comprises a touch sensitive user input facility, such as one or more mouse-keyboards or a virtual keyboard, that measures key touches and determines which key is touched by which finger tip of the user 210. The virtual keyboard can optionally be projected or presented on a adjustable display 110, optionally with a transparent hand model rendering to help the user with keyboard input without requiring that the user see what is entered on the physical input device. Helper layers are optionally employed to selectively present one or more enriched renderings.

The techniques described herein can also include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques described herein can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

Additionally, an embodiment of the present invention can make use of software running on a computer or workstation. With reference to FIG. 6, such an implementation might employ, for example, a processor 602, a memory 604, and an input/output interface formed, for example, by a display 606 and a keyboard 608. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 602, memory 604, and input/output interface such as display 606 and keyboard 608 can be interconnected, for example, via bus 610 as part of a data processing unit 612. Suitable interconnections, for example via bus 610, can also be provided to a network interface 614, such as a network card, which can be provided to interface with a computer network, and to a media interface 616, such as a diskette or CD-ROM drive, which can be provided to interface with media 618.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 602 coupled directly or indirectly to memory elements 604 through a system bus 610. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 608, displays 606, pointing devices, and the like) can be coupled to the system either directly (such as via bus 610) or through intervening I/O controllers (omitted for clarity).

Network adapters such as network interface 614 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 612 as shown in FIG. 6) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out embodiments of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present invention.

Embodiments of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 602. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, facilitating a user to operate a computing device in an atypical body position, such as a user lying in a horizontal position while using a computing device.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
providing an adjustable display for a computing system of a user;
obtaining one or more images of said user from a vicinity of said adjustable display generated by a camera that is in a non-contact position with respect to said user;
evaluating a relative position of one or more of eyes and ears of said user and said adjustable display using said one or more images to determine whether said user is facing said adjustable display; and
readjusting one or more of a position and an orientation of said adjustable display based on said relative position.

2. The computer-implemented method of claim 1, further comprising the step of collecting user preferences indicating a preferred position of said adjustable display.

3. The computer-implemented method of claim 2, further comprising the step of initially positioning said adjustable display at start-up based on said preferred position of said adjustable display.

4. The computer-implemented method of claim 1, further comprising the step of storing said position of said adjustable display following a manual adjustment by said user.

5. The computer-implemented method of claim 1, further comprising the step of restoring said position of said adjustable display to a default position following one or more of said computing device and said user being idle for a predefined period of time.

6. The computer-implemented method of claim 5, wherein the predefined period of time is configurable by the user.

7. The computer-implemented method of claim 1, further comprising the steps of presenting a touch-sensitive virtual keyboard to the user and rendering a semi-transparent model of one or more hands of the user on the virtual keyboard.

8. The computer-implemented method of claim 1, further comprising the step of selectively presenting one or more helper layers on said adjustable display, wherein said helper layers render one or more of a touch-sensitive virtual keyboard, a semi-transparent hand model indicating a current position of at least one hand of the user and a user interface guide.

9. The computer-implemented method of claim 1, wherein said step of evaluating said relative position of one or more of said eyes and said ears of said user further comprises evaluating a facial pose of said user.

10. The computer-implemented method of claim 9, wherein said step of evaluating a facial pose of said user further comprises one or more steps of (i) determining whether a nose of said user is substantially visible as a front-facing view in images generated by the camera; (ii) determining whether both eyes of said user are substantially visible in images generated by the camera; and (iii) assigning a score to said facial pose of said user indicating a degree to which said user is facing said adjustable display.

11. A computer program product comprising a computer readable storage medium having program instructions embodied therewith, the program instructions executable by a device to cause the device to:
provide an adjustable display for a computing system of a user;
obtain one or more images of said user from a vicinity of said adjustable display generated by a camera that is in a non-contact position with respect to said user;
evaluate a relative position of one or more of eyes and ears of said user and said adjustable display using said one or more images to determine whether said user is facing said adjustable display; and
readjust one or more of a position and an orientation of said adjustable display based on said relative position.

12. A system comprising:
a memory; and
at least one processor coupled to the memory and configured for:
providing an adjustable display for a computing system of a user;
obtaining one or more images of said user from a vicinity of said adjustable display generated by a camera that is in a non-contact position with respect to said user;
evaluating a relative position of one or more of eyes and ears of said user and said adjustable display using said one or more images to determine whether said user is facing said adjustable display; and
readjusting one or more of a position and an orientation of said adjustable display based on said relative position.

13. The system of claim 12, wherein said at least one processor is further configured to collect user preferences indicating a preferred position of said adjustable display.

14. The system of claim 12, wherein said at least one processor is further configured to store said position of said adjustable display following a manual adjustment by said user.

15. The system of claim 12, wherein said at least one processor is further configured to restore said position of said adjustable display to a default position following one or more of said computing device and said user being idle for a predefined period of time.

16. The system of claim 15, wherein the predefined period of time is configurable by the user.

17. The system of claim 12, wherein said at least one processor is further configured to present a touch-sensitive virtual keyboard to the user and render a semi-transparent model of one or more hands of the user on the virtual keyboard.

18. The system of claim 12, wherein said at least one processor is further configured to selectively present one or more helper layers on said adjustable display, wherein said helper layers render one or more of a touch-sensitive virtual keyboard, a semi-transparent hand model indicating a current position of at least one hand of the user and a user interface guide.

19. The system of claim 12, wherein said relative position of one or more of said eyes and said ears of said user is evaluated by evaluating a facial pose of said user.

20. The system of claim 19, wherein said evaluation of said facial pose of said user further comprises one or more steps of (i) determining whether a nose of said user is substantially visible as a front-facing view in images generated by the camera; (ii) determining whether both eyes of said user are substantially visible in images generated by the camera; and (iii) assigning a score to said facial pose of said user indicating a degree to which said user is facing said adjustable display.
